(19) United States
(12) Patent Application Publication
(10) Pub. No.: US 2003/0061156 A1
(43) Pub. Date: Mar. 27, 2003

(54) Instant settlement system and method for credit card member stores

(76) Inventor: Sang-Jin Lim, Seoul (KR)

Correspondence Address: REED & EBERLE LLP, 800 MENLO AVENUE, SUITE 210, MENLO PARK, CA, 94025, US

(21) Appl. No.: 10/168,779

(22) PCT Filed: Dec. 19, 2000
(86) PCT No.: PCT/KR00/01491

(30) Foreign Application Priority Data
Dec. 21, 1999 (KR) 1999/60068
Nov. 16, 2000 (KR) 2000/67931

(51) Int. Cl. G06F 17/60

(52) U.S. Cl. 705/39; 705/40

(57) ABSTRACT

There is provided an instant settlement system for credit card member stores, which has a server including a branch-dedicated server connected to a branch, a VAN-dedicated server connected to a VAN (5), a withdrawal information server, a bank-dedicated server connected to a bank, a card-dedicated server connected to a credit card company (3), an account settlement server, and an inquiry processing server for managing a history database, member database and banking database, the server (4) being connected to a plurality of credit card member store terminals (21-25) to manage information about transaction made at credit card member stores, the server (6) being also connected to the bank, in case there is a transaction accomplished at a credit card member store, to control withdrawals to allow the credit card member store to be instantly paid for the transaction, the server being connected to the credit card company (3) through the VAN (5) to confirm if credit cards used for transactions are authorized and to process withdrawal for instant settlement.

### BACKGROUND OF THE INVENTION

1. Field of the Invention

The present invention relates to an instant settlement system and method for credit card member stores. More specifically, the invention relates to an instant settlement system and method for credit card member stores, in which settlement is instantly accomplished for credit card member stores when credit cards used for transactions made at the member stores are authorized by a credit card company, to allow the member stores to be well-financed, to facilitate management of settlement of accounts since payment is made for each of credit card transactions, and to manage the credit statuses of the credit card member stores so that the credit card company is not needed to manage them.

2. Description of the Related Art

Credit cards used as a payment means instead of cash in commercial transactions include a bank credit card such as BC card, VISA card, LG card, Samsung card, etc. and a department store credit card used in department stores. As of December 1999, the number of credit cards issued in Korea is 39 millions approximately and the number of credit card member stores are up to 1.2 millions. These numbers are increasing as the government encourages using of the credit cards.

A conventional process of settling credit card accounts is carried out through the following routine as shown in FIG. 1.

1. A cardholder 1 having a credit card issued by a credit card company 3 shows the credit card as a means for paying for goods or services to a credit card member store 2 where the cardholder purchased them.

2. The member store 2 requests the credit card company 3 to authorize the credit card using a credit card reader. When there is an authorization from the credit card company, the member store 2 provides the cardholder 1 with the goods or services and issues a sales check corresponding thereto.

3. When the credit card member store 2 requests the credit card company 3 to settle accounts for the sales check, the credit card company 3 settles them on the basis of authorization of credit card and the credit status of the member store 2.

4. The credit card company 3 asks the cardholder 1 to pay charges for the goods or services based on the sales check.

In the procedure of carrying out this conventional routine, however, when the member store 2 provides goods or services to the cardholder 1 and then requests the credit card company 3 to settle accounts for the sales check, the credit card company 3 does not settle them instantly but delays the payment by 2-7 days according to its circumstances. This affects the finance of the member store. Due to delayed settlement from the credit card company 3, the credit card member store 2 also has a difficult to manage the settlement statuses by credit card companies. When the credit card member store 2 deals with more various credit cards and has larger number of sales per day, it is more difficult to manage the settlement statuses by credit card companies.

### SUMMARY OF THE INVENTION

It is, therefore, an object of the present invention to provide an instant settlement system and method for credit card member stores, in which settlement is instantly accomplished for credit card member stores when credit cards used for transactions made at the member stores are authorized by a credit card company, to allow the member stores to be well-financed, to facilitate management of settlement of accounts since payment is made for each of credit card transactions, and to manage the credit statuses of the credit card member stores so that the credit card company is not needed to manage them.

Additional features and advantages of the invention will be set forth in the description that follows and in part will be apparent from the description or may be learned by practice of the invention. The objectives and other advantages of the invention will be realized and attained by the structure particularly pointed out in the written description and claims hereof as well as the appended drawings. Both the foregoing general description and the following detailed description are exemplary and explanatory only, and are not restrictive of the invention as claimed.

### BRIEF DESCRIPTION OF THE DRAWINGS

FIG. 1 illustrates a conventional process for settlement of credit card accounts;

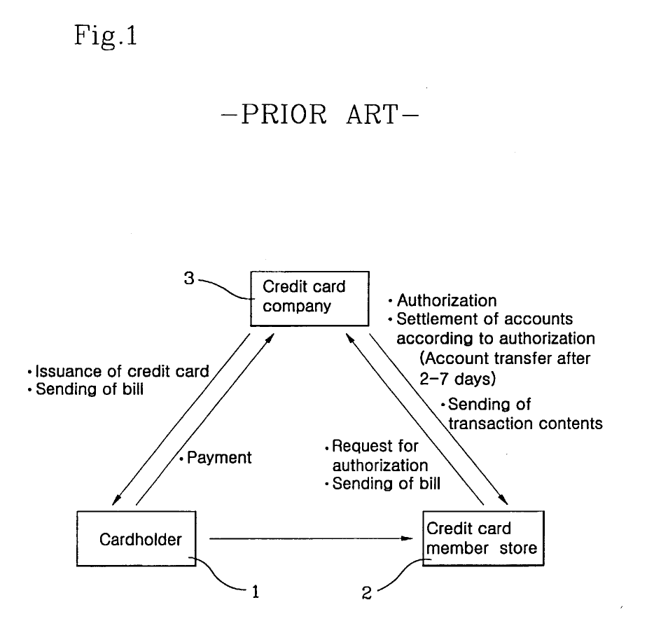

FIG. 2 illustrates a process of settlement of credit card accounts in an instant settlement system for credit card member stores in accordance with the present invention;

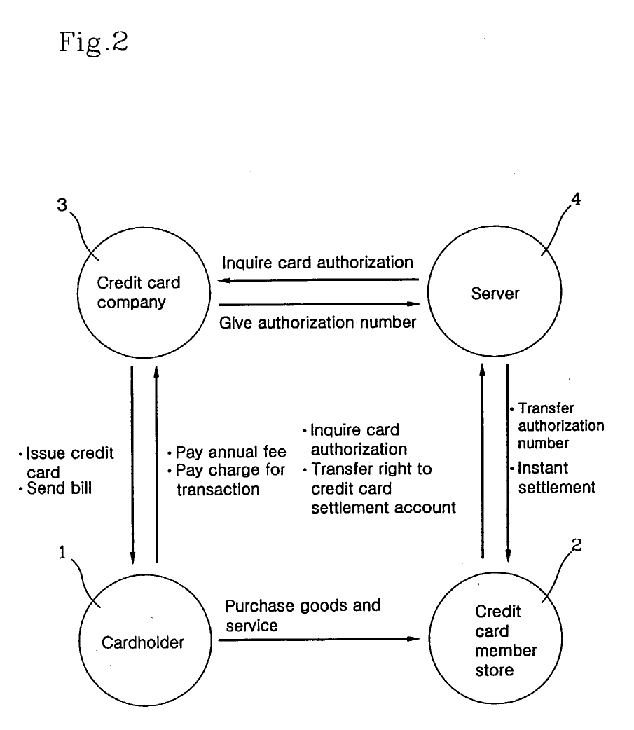

FIG. 3 illustrates the configuration of the instant settlement system for credit card member stores in accordance with the present invention; and

FIG. 4 illustrates the configuration of a server of the instant settlement system for credit card member stores in accordance with the present invention;

### DETAILED DESCRIPTION OF THE PREFERRED EMBODIMENT

Reference will now be made in detail to the preferred embodiments of the present invention, examples of which are illustrated in the accompanying drawings.

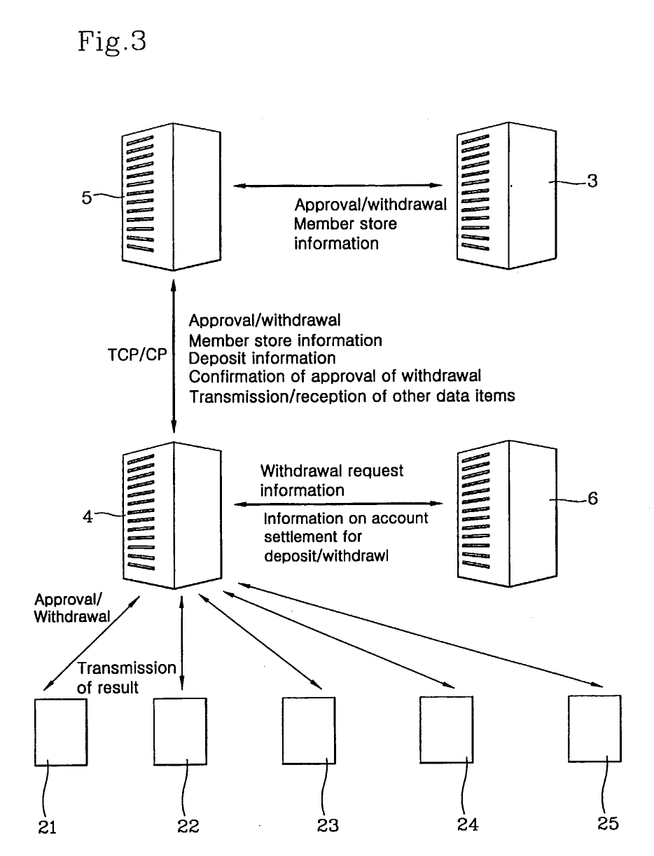

Referring to FIG. 3, an instant settlement system for credit card member stores in accordance with the invention is constructed in such a manner that a server 4 is connected to a plurality of credit card member store terminals 21-25 to manage information about transactions made at credit card member stores and it is also connected to a bank 6, in case there is a transaction accomplished at a credit card member store 2, to control withdrawals to allow the credit card member store 2 to be instantly paid for the transaction. The server 4 is also connected to a credit card company 3 through a VAN 5 to confirm whether credit cards used for transactions are authorized or not and to process withdrawal for instant settlement.

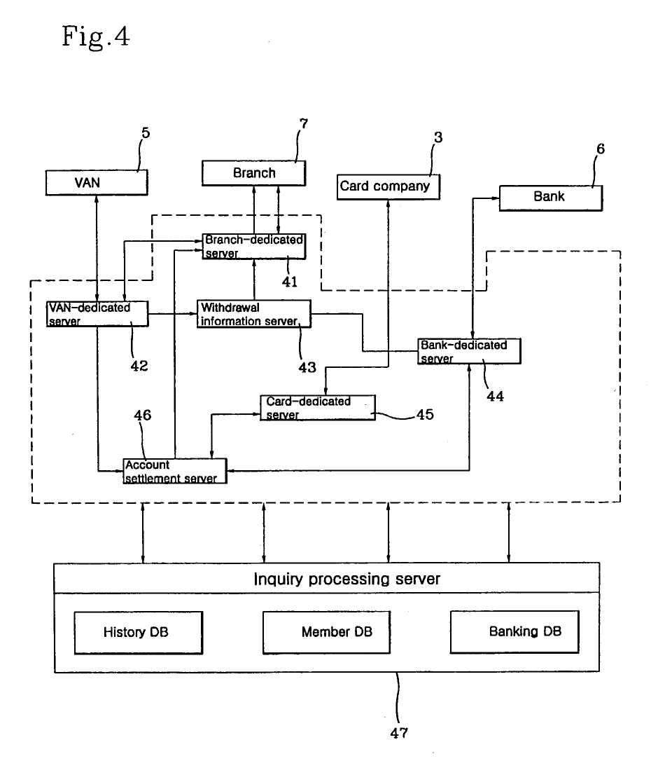

Referring to FIG. 4, the server 4 of the instant settlement system for credit card member stores in accordance with a preferred embodiment of the present invention includes a branch-dedicated server 41 connected to a branch 7, a VAN-dedicated server 42 connected to the VAN 5, a withdrawal information server 43, a bank-dedicated server 44 connected to the bank 6, a card-dedicated server 45 connected to the credit card company 3, an account settlement server 46, and an inquiry processing server 47 for managing a history database, member database and banking database.

For the credit card member store 2 subscribed through the branch 7, the branch-dedicated server 41 processes the member store owner's personal information, information about the store, and information related with a credit card reader used at the store. The branch-dedicated server 41 also processes information related with the credit card company 3 issuing credit cards to be used at the credit card member store 2, information related with instant settlement service contract, etc. The branch 7 and the head office manage these information items.

The VAN-dedicated server 42 takes charge of processing information about approval/withdrawal of credit cards carried out between the credit card company 3 and credit card member stores via the VAN, registration information and changed information about the credit card member store 2 raised using a precondition of using the instant settlement system, and registration information and changed information about the credit card company. The VAN-dedicated server 42 also processes credit card reader registration information and changed information, approval/withdrawal information required for operating the instant settlement system, information on redundant approval, information about return of card authorization information and information on withdrawal from the card company according to the instant settlement.

The withdrawal information server 43 takes charge of searching a instant settlement service credit limit, the number of times of the instant settlement service and bad transaction contents, searching and processing a balance for approval of cancellation and searching and processing a balance. The withdrawal information server 43 also takes charge of verifying and processing validation of card percentage rates varied by the credit card company 3, tracing and processing bad transactions such as self-sales and false sales, and generation of withdrawal information for the instant settlement service.

The bank-dedicated server 44 requests for withdrawal from the bank 6 for a withdrawal request message that is the result processed by the withdrawal information server 43, verifies reception of the withdrawal request by the bank 6 and accuracy thereof, receives and verifies the result processed by the bank 6 for the withdrawal request. The bank-dedicated server 44 further takes charge of processing errors on the withdrawal request message, reception and verification of deposit details of the credit card, processing withdrawal of instant settlement accounts and verification of the withdrawal result, and verification of files of account settlement between the bank and credit card company.

The card-dedicated server 45 is in charge of cross-checking and verification of card company deposit information accepted from the VAN 5, and collection and verification of information about deposit information of a card company that is not affiliated with the VAN 5.

The account settlement server 46 compares the deposit details of the card company 3 accepted from the VAN-dedicated server 42, withdrawal information previously processed by the withdrawal information server 43 and bank deposit details accepted from the bank-dedicated server 44 with one another, to take charge of settlement of deposit/withdrawal accounts, settlement of accounts for over-withdrawal and not-yet-withdrawal for instant settlement for the member stores, settlement of accounts for withdrawal contents for member store credit limits and personal credit limits, and settlement of various percentage rates related with operations of the VAN 5 and bank 6.

The inquiry processing server 47 includes a member database for managing information related with member store subscribers, a history database for managing histories such as authorization, cancellation, withdrawal, payment, balance, etc. and a banking database for managing a database related with the operation of bank such as withdrawal and deposit.

The method for processing settlement of credit card accounts using the aforementioned configuration according to a preferred embodiment of the present invention is carried out through the following routines.

1. The cardholder 1 having a credit card issued by the credit card company 3 shows his credit card as a means for paying charges for goods or services to a credit card member store 2 that provides the goods or services.

2. The credit card member store 2 requests the credit card company 3 to authorize the credit card via the server 4 and VAN 5 using a credit card reader. When the card company 3 authorizes the card, the member store 2 provides the cardholder 1 with the goods or services and issues a sales check corresponding thereto.

3. The server 4 instantly settles accounts for the credit card member store 2 on the basis of the authorization information.

4. The server 4 withdraws the instantly settled account from the credit card company 3 through a predetermined validation procedure.

5. The credit card company 3 asks the cardholder 1 to pay the charges for the goods or service he purchased on the basis of the sales check.

There is explained now the instant settlement system and method for credit card member stores according to a predetermined embodiment of the present invention.

The server 4 is connected to the host of the credit card company 3 through the host of the VAN 5 via a leased line and Internet communication network and it is also connected to the credit card member store terminals 21-25 through a leased line, Internet communication network, telephone network, mobile communication network, etc., to allow the credit card of the cardholder 1 to be authorized by the credit card company 3 through the credit card member store terminal via the server 4 and VAN 5 when the credit card is used for a transaction made at the credit card member store 2.

When a customer wants to pay charges for goods purchased at the credit card member store 2 using his credit card, the credit card member store terminal of the member store 2 requests the host of the credit card company to approve the credit card through the server 4 and VAN 5. Then, an authorization number is displayed on the credit card member store terminal through the VAN 5 and server 4. After this authorization, a sales check is issued to the cardholder 1 from the credit card member store terminal.

Meantime, when the customer wants to pay charges for goods purchased at the credit card member store 2 using his credit card, the credit card member store terminal of the requests the credit card company 3 to authorize the credit card through the VAN 5 without passing through the server 4 so that the authorization number is displayed on the terminal via the VAN 5. When the credit card company authorizes the credit card, the credit card member store terminal issues a sales check to the cardholder 1 and the VAN 5 informs the server 4 of the authorization.

The bank-dedicated server 44 of the server 4 transfers an amount of money from which a predetermined percentage rate has been deducted from the account of the bank 6 to the account of the credit card member store through a firm banking system using PC banking, phone banking and leased line for credit card transactions which are approved. That is, the bank-dedicated server 44 of the server 4 transfers money from the account of the bank 6 to the account of the credit card member store 2 through the firm banking system using the PC banking, phone banking and leased line.

When the transfer is instantly accomplished from the account of the bank 6 to the account of the credit card member store, the withdrawal information server 43 records and manages this.

The credit card member store 2 becomes well financed and is able to easily manage settlement of accounts for credit card transactions because it is paid for credit card transactions instantly. All kinds of businesses such as department stores, hospitals, hotels, coffee shops, beauty shops, restaurants, clothing shops, etc. including existing credit card member stores can be the credit card member store. The terminal having software suitable for the configuration of the settlement system and a network are previously prepared and installed in the credit card member stores.

The card-dedicated server 45 of the sever 4 withdraws the account instantly settled from corresponding credit card company 3 through a predetermined validation procedure. This is recorded and managed by the account settlement server 46. The credit card company 3 requests the cardholder 1 to pay for a transaction on the basis of the sales check. Then, the cardholder 1 pays the transaction account.

As described above, the present invention instantly settles accounts for credit card member stores when credit cards used for transactions made at the member stores are authorized by a credit card company, to allow the member stores to be well-financed, to facilitate management of settlement of accounts since payment is made for each of credit card transactions, and to manage the credit statuses of the credit card member stores so that the credit card company is not needed to manage them.

While certain embodiments and details have been shown for the purpose of illustrating the present invention, it will be apparent to those skilled in the art that various changes and modifications may be made herein without departing from the spirit or scope of the invention.

What is claimed is:

1. An instant settlement system for credit card member stores, which has a server including a branch-dedicated server connected to a branch, a VAN-dedicated server connected to a VAN, a withdrawal information server, a bank-dedicated server connected to a bank, a card-dedicated server connected to a credit card company, an account settlement server, and an inquiry processing server for managing a history database, member database and banking database, the server being connected to a plurality of credit card member store terminals to manage information about transactions made at credit card member stores, the server being also connected to the bank, in case there is a transaction accomplished at a credit card member store, to control withdrawals to allow the credit card member store to be instantly paid for the transaction, the server being connected to the credit card company through the VAN to confirm if credit cards used for transactions are authorized and to process withdrawal for instant settlement.

2. The instant settlement system for credit card member stores as claimed in claim 1, wherein the branch-dedicated server, for the credit card member store subscribed through the branch, processes the member store owner's personal information, information about the store, information related with a credit card reader used at the store, information related with the credit card company issuing credit cards to be used at the credit card member store, and information related with instant settlement service contract, these information being managed by the branch and head office.

3. The instant settlement system for credit card member stores as claimed in claim 1, wherein the VAN-dedicated server takes charge of processing information about approval/withdrawal of credit cards carried out between the credit card company and credit card member stores via the VAN, registration information and changed information about the credit card member store raised using a precondition of using the instant settlement system, registration information and changed information about the credit card company, credit card reader registration information and changed information, approval/withdrawal information required for operating the instant settlement system, information on redundant approval, information about return of card authorization information, and information on withdrawal from the card company according to the instant settlement.

4. The instant settlement system for credit card member stores as claimed in claim 1, wherein the withdrawal information server takes charge of searching a instant settlement service credit limit, the number of times of the instant settlement service and bad transaction contents, searching and processing a balance for approval of cancellation and searching and processing a balance, verifying and processing validation of card percentage rates varied by the credit card company, tracing and processing bad transactions such as self-sales and false sales, and generation of withdrawal information for the instant settlement service.

5. The instant settlement system for credit card member stores as claimed in claim 1, wherein the bank-dedicated server requests for withdrawal from the bank for a withdrawal request message that is the result processed by the withdrawal information server, verifies reception of the withdrawal request by the bank and accuracy thereof, receives and verifies the result processed by the bank for the withdrawal request, processes errors on the withdrawal request message, receives and verifies deposit details of the credit card, processes withdrawal of instant settlement accounts, verifies the withdrawal result, and verifies files of account settlement between the bank and credit card company.

6. The instant settlement system for credit card member stores as claimed in claim 1, wherein the card-dedicated server is in charge of cross-checking and verification of card company deposit information accepted from the VAN, and collection and verification of information about deposit information of a card company that is not affiliated with the VAN.

7. The instant settlement system for credit card member stores as claimed in claim 1, wherein the account settlement server compares the deposit details of the card company accepted from the VAN-dedicated server, withdrawal information previously processed by the withdrawal information server and bank deposit details accepted from the bank-dedicated server with one another, to take charge of settlement of deposit/withdrawal accounts, settlement of accounts for over-withdrawal and not-yet-withdrawal for instant settlement for the member stores, settlement of accounts for withdrawal contents for member store credit limits and personal credit limits, and settlement of various percentage rates related with operations of the VAN and bank.

8. The instant settlement system for credit card member stores as claimed in claim 1, wherein the inquiry processing server includes a member database for managing information related with member store subscribers, a history database for managing histories such as authorization, cancellation, withdrawal, payment, balance, etc. and a banking database for managing a database related with the operation of bank such as withdrawal and deposit.

9. An instant settlement method for credit card member stores, comprising:
a step in which, when a cardholder having a credit card issued by a credit card company shows his credit card as a means for paying charges for goods or services to a credit card member store that provides the goods or services, the credit card member store requests the credit card company to authorize the credit card via a server and VAN using a credit card reader;
a step in which, when the card company authorizes the credit card, the member store provides the cardholder with the goods or services and issues a sales check corresponding thereto;
a step in which the server instantly settles accounts for the credit card member store on the basis of the authorization information; and
a step in which the server withdraws the instantly settled account from the credit card company through a predetermined validation procedure.

10. An instant settlement method for credit card member stores, comprising:
a step in which, when a cardholder having a credit card issued by a credit card company shows his credit card as a means for paying charges for goods or services to a credit card member store that provides the goods or services, the credit card member store requests the credit card company to authorize the credit card via a server and VAN using a credit card reader;
a step in which, when the card company authorizes the credit card, the member store provides the cardholder with the goods or services and issues a sales check corresponding thereto;
a step in which, when the card company authorizes the credit card, the VAN informs the server of the authorization;
a step in which the server instantly settles accounts for the credit card member store on the basis of the authorization information; and
a step in which the server withdraws the instantly settled account from the credit card company through a predetermined validation procedure.
